(19) United States
(12) Patent Application Publication
(10) Pub. No.: US 2025/0198762 A1
(43) Pub. Date: Jun. 19, 2025

(54) MOTION INFORMATION FOR VEHICLE COMBINATIONS

(71) Applicant: VOLVO TRUCK CORPORATION, Göteborg (SE)

(72) Inventors: Esteban Gelso, Västra Frölunda (SE); Maliheh Sadeghi Kati, Öjersjö (SE); Salmane Essayeh, Göteborg (SE)

(73) Assignee: VOLVO TRUCK CORPORATION, Göteborg (SE)

(21) Appl. No.: 18/983,761

(22) Filed: Dec. 17, 2024

(30) Foreign Application Priority Data
Dec. 18, 2023 (EP) 23217683.4

(51) Int. Cl. G01C 21/16; G07C 5/02

(52) U.S. Cl. CPC G01C 21/165; G07C 5/02

(57) ABSTRACT

A computer system has processing circuitry to acquire a first set of parameters relating to a first unit of a vehicle combination, the first set of parameters comprising a longitudinal acceleration of the first unit, a lateral acceleration of the first unit, a yaw rate of the first unit, and a first distance between the centre of gravity of the first unit and a coupling point between the first unit and a second unit of the vehicle combination, acquire a second set of parameters relating to the second unit, the second set of parameters comprising a longitudinal tyre force of the second unit, a mass of the second unit, and a second distance between the centre of gravity of the second unit and the coupling point, acquire a longitudinal coupling force and a lateral coupling force between the first unit and the second unit, and determine an articulation angle between the first unit and the second unit based on the acquired first set of parameters, second set of parameters, longitudinal coupling force, and lateral coupling force.

### TECHNICAL FIELD

The disclosure relates generally to vehicle control. In particular aspects, the disclosure relates to motion information for vehicle combinations. The disclosure can be applied to heavy-duty vehicles, such as trucks, buses, and construction equipment, among other vehicle types. Although the disclosure may be described with respect to a particular vehicle, the disclosure is not restricted to any particular vehicle.

### BACKGROUND

The absence of state measurement for the trailing units in the traditional vehicle combination setup poses a significant safety concern. Without real-time data on signals such as accelerations, coupling forces and articulation angles, ensuring a safe envelope of motion for the vehicle combination becomes a challenging task. This lack of information not only hinders the driver's ability to precisely gauge the trailer unit's stability, but also severely limits the effectiveness of safety functionalities. As a result, critical situations such as trailer swing or roll-over become harder to predict and avoid, potentially leading to hazardous incidents on the road. In cases where state measurement for trailing units is available, there is still a need to check the quality of the measurement (detection of faulty values) and to provide reliable values in e.g. safety critical autonomous applications.

It is therefore desired to provide systems, methods and other approaches that attempt to resolve or at least mitigate one or more of these issues.

### SUMMARY

This disclosure provides systems, methods and other approaches for determining motion information for a vehicle combination comprising a tractor unit and one or more trailer units. In particular, a computer system is provided comprising processing circuitry configured to acquire certain parameters relating to a first unit and a second unit of a vehicle combination. Based on the acquired parameters, a new set of parameters relating to the second unit can be determined. In particular, an articulation angle between the first unit and the second unit can be determined. Longitudinal and lateral coupling forces between the units, and longitudinal and lateral accelerations of the second unit, can also be determined.

According to a first aspect of the disclosure, there is provided a computer system comprising processing circuitry configured to acquire a first set of parameters relating to a first unit of a vehicle combination, the first set of parameters comprising a longitudinal acceleration of the first unit, a lateral acceleration of the first unit, a yaw rate of the first unit, and a first distance between the centre of gravity of the first unit and a coupling point between the first unit and a second unit of the vehicle combination, acquire a second set of parameters relating to the second unit, the second set of parameters comprising a longitudinal tyre force of the second unit, a mass of the second unit, and a second distance between the centre of gravity of the second unit and the coupling point, acquire a longitudinal coupling force and a lateral coupling force between the first unit and the second unit, and determine an articulation angle between the first unit and the second unit based on the acquired first set of parameters, second set of parameters, longitudinal coupling force, and lateral coupling force.

The first aspect of the disclosure may seek to provide an estimation of second unit states based on signals from a first unit. A technical benefit may include that the newly determined parameters can be used as an input to a “soft” inertial measurement unit (IMU) or to provide a backup system in case of communication problems. This can also function as a redundant system and can be used to verify corresponding parameters of a separate system. This increases the reliability of measurements and provides a solution for fault detection and mitigation, meaning that safe operation of vehicle combinations can be ensured. In particular, these approaches further open the possibility for safety critical autonomous applications.

Optionally in some examples, including in at least one preferred example, the first set of parameters further comprises a yaw acceleration of the first unit, and the processing circuitry is further configured to determine a longitudinal acceleration of the second unit and/or a lateral acceleration of the second unit based on the acquired first set of parameters, the acquired second set of parameters, and the determined articulation angle. A technical benefit may include the provision of further parameters, in particular acceleration of a second unit, that may otherwise not be available.

Optionally in some examples, including in at least one preferred example, the processing circuitry is configured to determine a longitudinal acceleration of the second unit based on the determined articulation angle, the longitudinal acceleration of the first unit, the lateral acceleration of the first unit, the yaw acceleration of the first unit, and the first distance. A technical benefit may include the provision of further parameters, in particular a longitudinal acceleration of a second unit, that may otherwise not be available.

Optionally in some examples, including in at least one preferred example, the processing circuitry is configured to determine a lateral acceleration of the second unit based on the determined articulation angle, the longitudinal acceleration of the first unit, the lateral acceleration of the first unit, the yaw acceleration of the first unit, the distance between the centre of gravity of the first unit and the coupling point, and the second distance. A technical benefit may include the provision of further parameters, in particular a lateral acceleration of a second unit, that may otherwise not be available.

Optionally in some examples, including in at least one preferred example, the processing circuitry is further configured to use the longitudinal coupling force, the lateral coupling force, the articulation angle, the longitudinal acceleration of the second unit and/or the lateral acceleration of the second unit as an input to an inertial measurement unit, IMU, for motion management of the vehicle combination. A technical benefit may include the provision of a backup IMU backup in case of a communication problem between IMUs of the individual units, or failure or low accuracy of a primary IMU of the vehicle.

Optionally in some examples, including in at least one preferred example, the processing circuitry is configured to use the longitudinal coupling force, the lateral coupling force, the articulation angle, the longitudinal acceleration of the second unit and/or the lateral acceleration of the second unit to verify corresponding parameters of a separate vehicle motion or localization unit, a primary IMU of the vehicle combination, or global navigation satellite system, GNSS, based sensor equipment. A technical benefit may include an increase in the reliability of measurements and the provision of a solution for fault detection and mitigation, meaning that safe operation of vehicle combinations can be ensured

Optionally in some examples, including in at least one preferred example, the processing circuitry is configured to acquire the longitudinal coupling force and the lateral coupling force by acquiring a sum of longitudinal tyre forces of the first unit, a sum of lateral tyre forces of the first unit, and a mass of the first unit, and determining the longitudinal coupling force and the lateral coupling force based on the acquired longitudinal acceleration of the first unit, lateral acceleration of the first unit, sum of longitudinal tyre forces, sum of lateral tyre forces, and mass of the first unit. A technical benefit may include the provision of further parameters, in particular a coupling forces between units, that may otherwise not be available.

Optionally in some examples, including in at least one preferred example, the processing circuitry is configured to acquire at least some of the first set of parameters from a sensor system of the first unit of the vehicle combination. A technical benefit may include provision of further parameters that may otherwise not be available based on existing infrastructure of the vehicle combination.

Optionally in some examples, including in at least one preferred example, the processing circuitry is configured to acquire the longitudinal tyre force of the second unit from a braking system and/or propulsion system of the second unit. A technical benefit may include provision of further parameters that may otherwise not be available based on existing infrastructure of the vehicle combination.

Optionally in some examples, including in at least one preferred example, the computer system is an electronic control unit, ECU, of the first unit, and the longitudinal coupling force, the lateral coupling force, the articulation angle, the longitudinal acceleration of the second unit and/or the lateral acceleration of the second unit are stored in a memory associated with the ECU of the first unit. A technical benefit may include ensuring the availability of parameters of the second unit even when communication is hindered.

Optionally in some examples, including in at least one preferred example, the computer system is an electronic control unit, ECU, of the second unit, wherein the processing circuitry is configured to use the longitudinal coupling force, the lateral coupling force, the articulation angle, the longitudinal acceleration of the second unit and/or the lateral acceleration of the second unit as a redundancy for determination of parameters by the second unit. A technical benefit may include the provision of a redundancy for determination of parameters by the second unit.

According to a second aspect of the disclosure, there is provided a vehicle comprising the computer system. The second aspect of the disclosure may seek to provide a vehicle for which estimation of second unit parameters that may otherwise not be available is provided.

According to a third aspect of the disclosure, there is provided a computer-implemented method comprising acquiring, by processing circuitry of a computer system, a first set of parameters relating to a first unit of a vehicle combination, the first set of parameters comprising a longitudinal acceleration of the first unit, a lateral acceleration of the first unit, a yaw rate of the first unit, and a distance between the centre of gravity of the first unit and a coupling point between the first unit and the second unit, acquiring, by the processing circuitry, a second set of parameters relating to a second unit of the vehicle combination, the second set of parameters comprising a longitudinal tyre force of the second unit, a mass of the second unit, and a distance between the centre of gravity of the second unit and the coupling point, and acquiring, by the processing circuitry, a longitudinal coupling force and a lateral coupling force between the first unit and the second unit, and determining, by the processing circuitry, an articulation angle between the first unit and the second unit based on the acquired first set of parameters, second set of parameters, longitudinal coupling force, and lateral coupling force.

The third aspect of the disclosure may seek to provide an estimation of second unit states based on signals from a first unit. A technical benefit may include that the newly determined parameters can be used as an input to a “soft” inertial measurement unit (IMU) or to provide a backup system in case of communication problems. This can also function as a redundant system and can be used to verify corresponding parameters of a separate system. This increases the reliability of measurements and provides a solution for fault detection and mitigation, meaning that safe operation of vehicle combinations can be ensured. In particular, these approaches further open the possibility for safety critical autonomous applications.

According to a fourth aspect of the disclosure, there is provided a computer program product comprising program code for performing, when executed by processing circuitry, the computer-implemented method. A technical benefit may include that new vehicles and/or legacy vehicles may be conveniently configured, by software installation/update, to benefit from estimation of second unit parameters that may otherwise not be available.

According to a fifth aspect of the disclosure, there is provided a non-transitory computer-readable storage medium comprising instructions, which when executed by processing circuitry, cause the processing circuitry to perform the computer-implemented method. A technical benefit may include that new vehicles and/or legacy vehicles may be conveniently configured, by software installation/update, to benefit from estimation of second unit parameters that may otherwise not be available.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

There are also disclosed herein computer systems, control units, code modules, computer-implemented methods, computer readable media, and computer program products associated with the above discussed technical benefits.

### BRIEF DESCRIPTION OF THE DRAWINGS

Examples are described in more detail below with reference to the appended drawings.

FIG. 1 schematically shows a top view of a vehicle combination according to an example.

FIG. 2 is a flow chart of a computer-implemented method according to an example.

FIG. 3 is a schematic diagram of a computer system for implementing examples disclosed herein.

Like reference numerals refer to like elements throughout the description.

### DETAILED DESCRIPTION

The detailed description set forth below provides information and examples of the disclosed technology with sufficient detail to enable those skilled in the art to practice the disclosure.

The absence of state measurement for the trailing units in the traditional vehicle combination setup poses a significant safety concern. Without real-time data on signals such as accelerations, coupling forces and articulation angles, ensuring a safe envelope of motion for the vehicle combination becomes a challenging task. This potentially leads to hazardous incidents on the road. In cases where state measurement for trailing units is available, there is still a need to check the quality of the measurement and to provide reliable values.

To remedy this, systems, methods and other approaches are provided for determining motion information for vehicle combinations. A computer system is provided comprising processing circuitry configured to acquire certain parameters relating to a first unit and a second unit of a vehicle combination. Based on the acquired parameters, a new set of parameters relating to the second unit can be determined. As such, the approaches disclosed herein may aim to provide an estimation of trailing unit parameters based on signals from a tractor unit. In particular, an articulation angle between the first unit and the second unit can be determined. Longitudinal and lateral coupling forces between the units, and longitudinal and lateral accelerations of the second unit, can also be determined.

By determining a set of parameters relating to the second unit in this way, they can be used as an input to a “soft” inertial measurement unit (IMU) in the case that the second unit does not provide any measurements, which is often the case in traditional vehicle combinations. For example, a soft IMU could be implemented in a control unit in the first unit, and could therefore be a backup method in case of a communication problem between an IMU in the second unit and the first unit, or failure or low accuracy of a primary IMU of the vehicle. This can also function as a redundant system when the trailer unit possesses an individual IMU. The determined parameters can be used to verify corresponding parameters of a separate vehicle motion or localization unit, a primary IMU of the vehicle, or global navigation satellite system (GNSS) based sensor equipment. This increases the reliability of measurements and provides a solution for fault detection and mitigation, meaning that safe operation of vehicle combinations can be ensured. In particular, these approaches further open the possibility for safety critical autonomous applications.

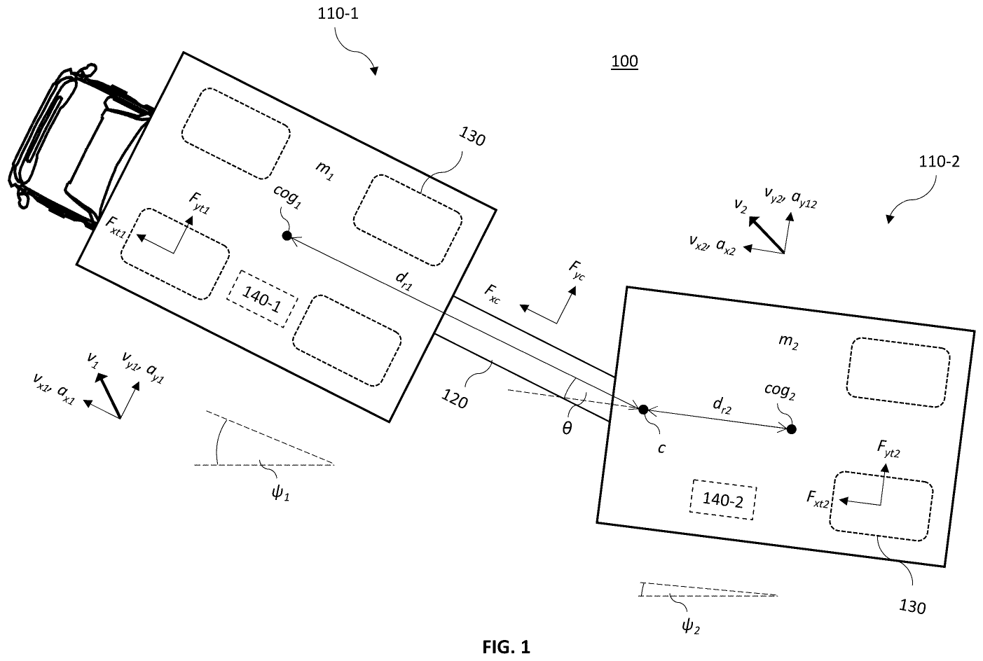

FIG. 1 schematically shows a top view of an example vehicle combination 100 of the type considered in this disclosure. The vehicle combination 100 comprises a number of units 110, including a tractor unit 110-1 and a trailing unit 110-2 connected by a coupling 120. Whilst a single trailing unit 110-2 is shown, it will be appreciated that the vehicle combination 100 may comprise further trailing units. This gives rise to different types and designations of vehicle combinations.

A tractor unit, such as the tractor unit 110-1, is generally the foremost unit in a vehicle combination 100, and may comprise the cabin for the driver, including steering controls, dashboard displays and the like. Generally, the tractor unit 110-1 is used to provide propulsion power for the vehicle combination 100. In the example of FIG. 1, the tractor unit 110-1 may also be used to store goods that are being transported by the vehicle combination 100.

A trailing unit, such as the trailing unit 110-2, is generally used to store goods that are being transported by the vehicle combination 100. A trailing unit may be a truck, trailer, dolly and the like. A trailing unit may also provide propulsion to the vehicle combination 100. In vehicle combinations such as that shown in FIG. 1, vehicle motion management may be available on a unit level to receive requests from a manual or virtual driver to coordinate the propulsion, braking and steering.

Each unit 110 comprises a number of axles, each having a number of wheels 130. It will be appreciated that any suitable number of axles may be provide on the respective units 110. A trailing unit 110-2 without a front axle is known as a semi-trailer. It will also be appreciated that any number of the tractor axles and/or trailer axles may be driven axles, including zero (i.e. one of the units 110 may include at least one driven axle while the other does not).

Each unit 110 may also comprise a control unit 140. Each control unit 140 may be a vehicle control unit configured to perform various vehicle control functions, such as vehicle motion management. One function of the control units 140 is to provide control inputs for the vehicle combination 100, for example motion requests for the wheels 130. For example, each control unit 140 may be configured to control components of its respective unit 110, such as electrical machines, service brakes, suspension systems, steering systems, and the like, in order to implement the motion requests. These motion requests may relate to a requested manoeuvre for the vehicle combination 100, for example, straight-line driving, cornering, braking and the like.

In some implementations, the control unit 140-1 of the tractor unit 110-1 may be considered as the primary electronic control unit (ECU) of the vehicle combination 100, and may provide control signals for each unit. In some embodiments, a primary ECU may be implemented elsewhere in the vehicle combination 100, or may be a remote computer system, implemented at a distance from the vehicle combination 100. The control units 140 may be communicatively coupled in any suitable way, for example via a circuit or any other wired, wireless, or network connection known in the art. Furthermore, the communicative coupling may be implemented as a direct connection between the control units 140, or may be implemented as a connection via one or more intermediate entities. The control units 140 may be implemented as code running on a processing circuitry, or similar. The control units 140 may comprise processing circuitry configured to implement various operations disclosed below. The control units 140 may may include a memory storing instructions that, when executed by processing circuitry, cause the processing circuitry to perform the various operations.

FIG. 1 also shows various parameters of the vehicle combination 100. For example, each unit 110 has a respective mass m and a centre of gravity cog. The units 110 are coupled at a coupling point c. As such, each unit 110 has a respective distance dr between its centre of gravity cog and the coupling point c. The angle between the longitudinal axes of the respective units 110 is known as the articulation angle θ of the vehicle combination 100. Furthermore, a coupling force is present in the coupling 120 between the units. The coupling force can be considered as two components: a longitudinal coupling force F_{xc} and a lateral coupling force F_{yc}.

FIG. 1 also shows various parameters of the individual units 110. For example, each unit 110 has a respective velocity v which can be considered as two components: a longitudinal velocity vₓ and a lateral velocity v_{y}. Similarly, the acceleration of each unit can be considered as two components, a longitudinal acceleration aₓ and a lateral acceleration a_{y}. Each unit 110 has a respective yaw angle ψ, which is the angle between an environmental reference frame and the vehicle reference frame. The wheels 130 of each unit may also be subject to a tyre force Fₜ, which can also be considered as two components: a longitudinal tyre force Fₓₜ and a lateral tyre force F_{yt}. In the present disclosure, the tyre forces for each unit 110 are considered as a total force across all wheels 130, i.e. a sum of the individual tyre forces for all individual wheels 130.

As such, the following parameters are considered for the vehicle combination 100:
Mass m₁ of the tractor unit 110-1
Mass m₂ of the trailing unit 110-2
Distance dr₁ between centre of gravity cog₁ of the tractor unit 110-1 and the coupling point c
Distance dr₂ between centre of gravity cog₂ of the trailing unit 110-2 and the coupling point c
Articulation angle θ between the tractor unit 110-1 and the trailing unit 110-2 (as well as articulation angular rate \dot{θ})
Longitudinal coupling force F_{xc} between the tractor unit 110-1 and the trailing unit 110-2
Lateral coupling force F_{yc} between the tractor unit 110-1 and the trailing unit 110-2
Longitudinal velocity vₓ₁ of the tractor unit 110-1
Lateral velocity v_{y1} of the tractor unit 110-1
Longitudinal velocity vₓ₂ of the trailing unit 110-2
Lateral velocity v_{y2} of the trailing unit 110-2
Longitudinal acceleration aₓ₁ of the tractor unit 110-1
Lateral acceleration a_{y1} of the tractor unit 110-1
Longitudinal acceleration aₓ₂ of the trailing unit 110-2
Lateral acceleration a_{y2} of the trailing unit 110-2
Yaw angle ψ₁ (as well as yaw rate \dot{ψ}₁ and yaw acceleration \ddot{ψ}₁) of the tractor unit 110-1
Yaw angle ψ₂ (as well as yaw rate \dot{ψ}₂ and yaw acceleration \ddot{ψ}₂) of the trailing unit 110-2
Longitudinal tyre force Fₓₜ₁ of the tractor unit 110-1
Lateral tyre force F_{yt1} of the tractor unit 110-1
Longitudinal tyre force Fₓₜ₂ of the trailing unit 110-2
Lateral tyre force F_{yt2} of the trailing unit 110-2

As discussed above, in some implementations, not all of these parameters are readily available. For example, real-time data on signals such as accelerations, coupling forces and articulation angles may not be provided, making it challenging to ensure a safe envelope of motion for the vehicle combination 100. This can be a result of the absence of state measurement for the trailing unit 110-2. However, even in cases where state measurement for the trailing unit 110-2 is available, there is still a need to check the quality of the measurement and to provide reliable values. This is addressed in the present disclosure by the estimation of the previously unknown parameters based on those that are already available.

To do this, a number of motion equations for the vehicle combination 100 can be used. For the tractor unit 110-1, the following dynamic equations are used:

$${m}_{1} {a}_{x 1} = {F}_{xt 1} + {F}_{xc} \qquad ( 1 )$$

$${m}_{1} {a}_{y 1} = {F}_{yt 1} + {F}_{yc} \qquad ( 2 )$$

For the trailer unit 110-2, the following dynamic equations are used:

$${m}_{2} {a}_{x 2} = {F}_{xt 2} - ( {F}_{xc} cos θ - {F}_{yc} sin θ ) \qquad ( 3 )$$

$${m}_{2} {a}_{y 2} = {F}_{yt 2} - ( {F}_{xc} sin θ + {F}_{yc} cos θ ) \qquad ( 4 )$$

The kinematic constraint equations between the tractor unit 110-1 and the trailer unit 110-2 are as follows:

$${v}_{x 2} = {v}_{x 1} cos θ - ( {v}_{y 1} - {dr}_{1} {\dot{ψ}}_{1} ) sin θ \qquad ( 5 )$$

$${v}_{y 2} = {v}_{x 1} sin θ + ( {v}_{y 1} - {dr}_{1} {\dot{ψ}}_{1} ) cos θ - {dr}_{2} {\dot{ψ}}_{2} \qquad ( 6 )$$

Differentiating the kinematic constraint equations (5) and (6) gives:

$${a}_{x 2} = {a}_{x 1} cos θ - {v}_{x 1} sin θ \cdot \dot{θ} - {a}_{y 1} sin θ - {v}_{y 1} cos θ \cdot \dot{θ} + {dr}_{1} {\ddot{ψ}}_{1} sin θ + {dr}_{1} {\dot{ψ}}_{1} cos θ \cdot \dot{θ} \qquad ( 7 )$$

$${a}_{y 2} = {a}_{x 1} sin θ + {v}_{x 1} cos θ \cdot \dot{θ} + {a}_{y 1} cos θ - {v}_{y 1} sin θ \cdot \dot{θ} - {dr}_{1} cos θ {\ddot{ψ}}_{1} + {dr}_{1} {\dot{ψ}}_{1} \dot{θ} sin θ - {dr}_{2} {\ddot{ψ}}_{2} \qquad ( 8 )$$

Equations (1) to (8) can be used to determine a number of unknown parameters for the vehicle combination 100, as will be discussed below.

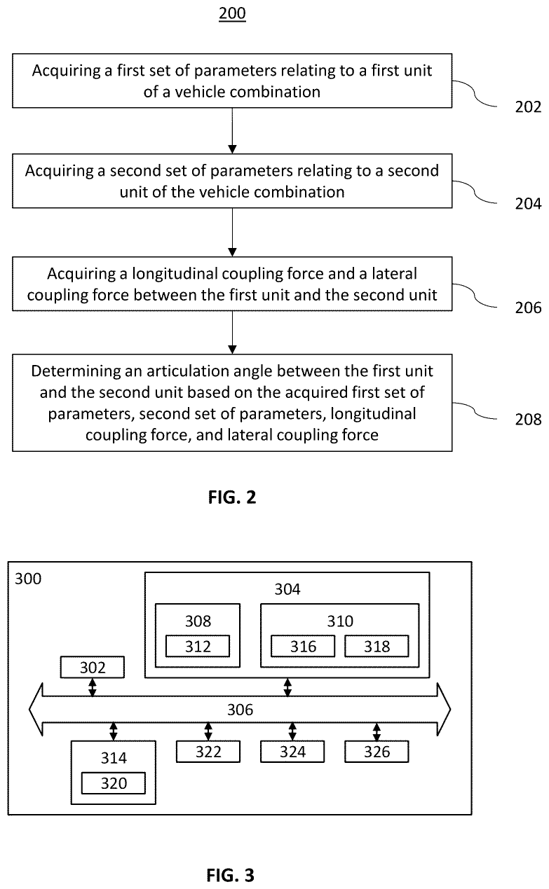

FIG. 2 is a flow chart of a computer-implemented method 200 according to an example. The method 200 may be implemented by processing circuitry of one or more of the control units 140 of the vehicle combination 100, or by processing circuitry of a remote computer system. Whilst the method 200 is described in relation to the vehicle combination 100 of FIG. 1, including a tractor unit 110-1 and a trailing unit 110-2, it will be appreciated that the vehicle combination 100 may comprise further trailing units, to which similar principles may be applied.

At 202, a first set of parameters relating to a first unit 110 of a vehicle combination 100 is acquired. In the example of FIG. 1, the first set of parameters relates to the tractor unit 110-1. In particular, the first set of parameters comprises the longitudinal acceleration aₓ₁ of the tractor unit 110-1, the lateral acceleration a_{y1} of the tractor unit 110-1, the yaw rate \dot{ψ}₁ of the tractor unit 110-1, and the distance dr₁ between centre of gravity cog₁ of the tractor unit 110-1 and the coupling point c.

At least some of the first set of parameters may be acquired from a sensor system of the tractor unit 110-1. For example, the tractor unit 110-1 may comprise wheel speed sensors, inertial measurement units, and the like, which enable one, more, or all of the first set of parameters to be determined. Certain information, for example the distance dr₁, may be predetermined and may be stored in a database.

At 204, a second set of parameters relating to a second unit 110 of the vehicle combination 100 is acquired. In the example of FIG. 1, the second set of parameters relates to the trailing unit 110-2. In particular, the second set of parameters comprises the longitudinal tyre force Fₓₜ₂ of the trailing unit 110-2, the mass m₂ of the trailing unit 110-2, and the distance dr₂ between centre of gravity cog₂ of the trailing unit 110-2 and the coupling point c.

The longitudinal tyre force Fₓₜ₂ may be determined from a braking system and/or propulsion system of the trailing unit 110-2. For example, in the case of a braking system, the braking force may be estimated from the a pressure sent to the trailing unit 110-2 and an axle load. In the case of a propulsion system, the torque input can be used with other relevant information to determine the force at the tyre level. Certain information, for example the mass m2 and the distance dr2, may be predetermined and may be stored in a database.

At 206, the longitudinal coupling force Fxc and the lateral coupling force Fyc between the tractor unit 110-1 and the trailing unit 110-2 are acquired. In some examples, the coupling forces F_{xc} and F_{yc} may be acquired from a sensor system associated with the coupling 120. In other examples, the coupling forces F_{xc} and F_{yc} may be determined using equations (1) and (2), as will be discussed below.

At 208, the articulation angle θ between the tractor unit 110-1 and the trailing unit 110-2 is determined based on the first set of parameters, the second set of parameters, and the coupling forces F_{xc} and F_{yc}. In particular, equations (1) to (8) can be used to determine the articulation angle θ as follows. The articulation angle θ can be expressed as:

$$θ = {ψ}_{1} - {ψ}_{2} \qquad ( 9 )$$

If it is assumed that the articulation angular rate \dot{θ} small, then:

$$\dot{θ} ≪ 1 ⇒ {\dot{ψ}}_{1} - {\dot{ψ}}_{2} ≪ 1 \qquad ( 10 )$$

$$⇒ {\dot{ψ}}_{1} \approx {\dot{ψ}}_{2} \qquad ( 11 )$$

Therefore, equations (7) and (8) can be formulated as follows:

$${a}_{x 2} = {a}_{x 1} cos θ - {a}_{y 1} sin θ + {dr}_{1} {\ddot{ψ}}_{1} sin θ \qquad ( 12 )$$

$${a}_{y 2} = {a}_{x 1} sin θ + {a}_{y 1} cos θ - {dr}_{1} {\ddot{ψ}}_{1} cos θ - {dr}_{2} {\ddot{ψ}}_{1} \qquad ( 13 )$$

Equations (1) and (2) can be formulated as follows:

$${F}_{xc} = {m}_{1} {a}_{x 1} - {F}_{xt 1} \qquad ( 14 )$$

$${F}_{yc} = {m}_{1} {a}_{y 1} - {F}_{y 1} \qquad ( 15 )$$

Then, injecting equation (12) into equation (3) gives:

$${m}_{2} {a}_{x 1} cos θ - {m}_{2} {a}_{y 1} sin θ + {m}_{2} {dr}_{1} {\dot{ψ}}_{1} sin θ = {F}_{xt 2} - {F}_{xc} cos θ + {F}_{yc} sin θ \qquad ( 16 )$$

$$( {m}_{2} {a}_{x 1} + {F}_{xc} ) cos θ - ( {m}_{2} {a}_{y 1} + {F}_{yc} - {m}_{2} {dr}_{1} {\dot{ψ}}_{1} ) sin θ = {F}_{xt 2} \qquad ( 17 )$$

Equation (17) is of type A cos θ−B sin θ=C, and can be solved as follows:

$$A cos θ = C + B sin θ \qquad ( 18 )$$

$${A}^{2} {cos}^{2} θ = {( C + B sin θ )}^{2} \qquad ( 19 )$$

$${A}^{2} ( 1 - {sin}^{2} θ ) = {C}^{2} + 2 BC sin θ + {B}^{2} {sin}^{2} θ \qquad ( 20 )$$

$$( {A}^{2} + {B}^{2} ) {sin}^{2} θ + 2 BC sin θ + ( {C}^{2} - {A}^{2} ) = 0 \qquad ( 21 )$$

Equation (21) is a quadratic equation and can be solved for θ. The equation can be solved in any suitable manner known in the art. As such, the articulation angle θ can be determined based on the first set of parameters, the second set of parameters, and the coupling forces F_{xc} and F_{yc}.

Once the articulation angle θ has been determined, the equations above can also be used to determine the longitudinal acceleration aₓ₂ and the lateral acceleration a_{y2} of the trailing unit 110-2 in cases that the first set of parameters further comprises the yaw acceleration \ddot{ψ}₁ of the tractor unit 110-1. In particular, using equation (12), the longitudinal acceleration aₓ₂ of the trailing unit 110-2 can be determined based on the determined articulation angle θ, the longitudinal acceleration aₓ₁ of the tractor unit 110-1, the lateral acceleration a_{y1} of the tractor unit 110-1, the yaw acceleration \ddot{ψ}₁ of the tractor unit 110-1, and the distance dr₁. Using equation (13), the lateral acceleration a_{y2} of the trailing unit 110-2 can be determined based on the determined articulation angle θ, the longitudinal acceleration aₓ₁ of the tractor unit 110-1, the lateral acceleration a_{y1} of the tractor unit 110-1, the yaw acceleration \ddot{ψ}₁ of the tractor unit 110-1, the distance dr₁, and distance dr₂. Once the lateral acceleration a_{y2} of the trailing unit 110-2 has determined, equation (4) could be used to determine the lateral tyre force F_{yt2} of the trailing unit 110-2.

As such, previously unknown parameters such as the articulation angle θ, the longitudinal acceleration aₓ₂ of the trailing unit 110-2, and the lateral acceleration a_{y2} of the trailing unit 110-2 can be estimated based on parameters that are already available.

As discussed above, the longitudinal coupling force F_{xc} and the lateral coupling force F_{yc} between the tractor unit 110-1 and the trailing unit 110-2 can be determined using equations (1) and (2). In this case, the longitudinal tyre force Fₓₜ₁ of the tractor unit 110-1, the lateral tyre force F_{yt1} of the tractor unit 110-1, and the mass m₁ of the tractor unit 110-1 are acquired. In this case, the tyre forces Fₓₜ₁ and F_{yt1} are sums of the respective tyre forces on the tractor unit 110-1. Using equation (1) (or equation (14)), the longitudinal coupling force F_{xc} can be determined based on the longitudinal acceleration aₓ₁ of the tractor unit 110-1, the sum of longitudinal tyre forces Fₓₜ₁ on the tractor unit 110-1, and the mass of the tractor unit 110-1. Similarly, using equation (2) (or equation (15)), the lateral coupling force F_{yc} can be determined based on the lateral acceleration a_{y1} of the tractor unit 110-1, the sum of lateral tyre forces F_{yt1} on the tractor unit 110-1, and the mass of the tractor unit 110-1. As such, the coupling forces F_{xc} and F_{yc} can be determined based on known parameters in the case that they are not directly measurable.

This approach can be implemented in a number of different ways. In particular, the newly determined parameters (for example, the articulation angle θ, the longitudinal acceleration aₓ₂ of the trailing unit 110-2, the lateral acceleration a_{y2} of the trailing unit 110-2, the longitudinal coupling force F_{xc}, and the lateral coupling force F_{yc}) can be used as an input to an IMU for motion management of the vehicle combination 100.

In one approach, this may be a “soft” IMU for use in the case that the second unit does not provide any measurements, which is often the case in traditional vehicle combinations. Such a soft IMU could be implemented in the control unit 140-1 of the tractor unit 110-1, and could therefore be a backup in case of a communication problem between IMUs of the individual units, or failure or low accuracy of a primary IMU of the vehicle.

In another approach, this may be implemented a redundant IMU when the trailing unit 110-2 possesses an individual IMU, for example implemented in the control unit 140-2. The determined parameters can be used to verify corresponding parameters of a separate vehicle motion or localization unit, a primary IMU of the vehicle, or GNSS based sensor equipment. For example, the determined parameters may be compared to corresponding parameters of a separate system to determine if the values of the separate system are within a reasonable and/or acceptable range of the determined parameters. This increases the reliability of measurements and provides a solution for fault detection and mitigation, meaning that safe operation of vehicle combinations can be ensured.

As such, a method may be provided in which a first set of parameters relating to the tractor unit 110-1 and a second set of parameters relating the trailing unit 110-2 are acquired, and a third set of parameters relating to the trailing unit 110-2 is determined based on the acquired first and second sets of parameters. The third set of parameters (for example, the articulation angle θ, the longitudinal acceleration aₓ₂ of the trailing unit 110-2, the lateral acceleration a_{y2} of the trailing unit 110-2, the longitudinal coupling force F_{xc}, and the lateral coupling force F_{yc}) can then be used as an input to an IMU for motion management of the vehicle combination 100, or to verify corresponding parameters of a separate vehicle motion or localization unit, a primary IMU of the vehicle combination 100, or GNSS based sensor equipment.

As discussed above, the method 200 may be implemented by processing circuitry of the control unit 140-1 of the tractor unit 110-1, or by processing circuitry of the control unit 140-2 of the trailing unit 110-2. In instances where the method is performed by the control unit 140-1 of the tractor unit 110-1, the newly determined parameters may be stored in a memory associated with the control unit 140-1 of the tractor unit 110-1. It may therefore be ensured that the newly determined parameters are still available from the tractor unit 110-1 if communication to the trailing unit 110-2 is degraded or partially lost. In this way, parameters of the trailing unit 110-2 are available even when communication is hindered. In instances where the method is performed by the control unit 140-2 of the trailing unit 110-2, the newly determined parameters may be provided as a redundancy for determination of parameters by the trailing unit 110-2, for example an IMU of the trailing unit 110-2.

FIG. 3 is a schematic diagram of a computer system 300 for implementing examples disclosed herein. In particular, the computer system 300 may, according to some examples, be configured to cause performance of the method 200 of FIG. 2 and/or to be comprised in the control unit 140 of FIG. 1. The computer system 300 is adapted to execute instructions from a computer-readable medium to perform these and/or any of the functions or processing described herein. The computer system 300 may be connected (e.g., networked) to other machines in a LAN, an intranet, an extranet, or the Internet. While only a single device is illustrated, the computer system 300 may include any collection of devices that individually or jointly execute a set (or multiple sets) of instructions to perform any one or more of the methodologies discussed herein. Accordingly, any reference in the disclosure and/or claims to a computer system, computing system, computer device, computing device, control system, control unit, electronic control unit (ECU), processor device, processing circuitry, etc., includes reference to one or more such devices to individually or jointly execute a set (or multiple sets) of instructions to perform any one or more of the methodologies discussed herein. For example, control system may include a single control unit or a plurality of control units connected or otherwise communicatively coupled to each other, such that any performed function may be distributed between the control units as desired. Further, such devices may communicate with each other or other devices by various system architectures, such as directly or via a Controller Area Network (CAN) bus, etc.

The computer system 300 may comprise at least one computing device or electronic device capable of including firmware, hardware, and/or executing software instructions to implement the functionality described herein. The computer system 300 may include processing circuitry 302 (e.g., processing circuitry including one or more processor devices or control units), a memory 304, and a system bus 306. The computer system 300 may include at least one computing device having the processing circuitry 302. The system bus 306 provides an interface for system components including, but not limited to, the memory 304 and the processing circuitry 302. The processing circuitry 302 may include any number of hardware components for conducting data or signal processing or for executing computer code stored in memory 304. The processing circuitry 302 may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processing circuitry 302 may further include computer executable code that controls operation of the programmable device.

The system bus 306 may be any of several types of bus structures that may further interconnect to a memory bus (with or without a memory controller), a peripheral bus, and/or a local bus using any of a variety of bus architectures. The memory 304 may be one or more devices for storing data and/or computer code for completing or facilitating methods described herein. The memory 304 may include database components, object code components, script components, or other types of information structure for supporting the various activities herein. Any distributed or local memory device may be utilized with the systems and methods of this description. The memory 304 may be communicably connected to the processing circuitry 302 (e.g., via a circuit or any other wired, wireless, or network connection) and may include computer code for executing one or more processes described herein. The memory 304 may include non-volatile memory 308 (e.g., read-only memory (ROM), erasable programmable read-only memory (EPROM), electrically erasable programmable read-only memory (EEPROM), etc.), and volatile memory 310 (e.g., random-access memory (RAM)), or any other medium which can be used to carry or store desired program code in the form of machine-executable instructions or data structures and which can be accessed by a computer or other machine with processing circuitry 302. A basic input/output system (BIOS) 312 may be stored in the non-volatile memory 308 and can include the basic routines that help to transfer information between elements within the computer system 300.

The computer system 300 may further include or be coupled to a non-transitory computer-readable storage medium such as the storage device 314, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 314 and other drives associated with computer-readable media and computer-usable media may provide non volatile storage of data, data structures, computer-executable instructions, and the like.

Computer-code which is hard or soft coded may be provided in the form of one or more modules. The module(s) can be implemented as software and/or hard-coded in circuitry to implement the functionality described herein in whole or in part. The modules may be stored in the storage device 314 and/or in the volatile memory 310, which may include an operating system 316 and/or one or more program modules 318. All or a portion of the examples disclosed herein may be implemented as a computer program 320 stored on a transitory or non-transitory computer-usable or computer-readable storage medium (e.g., single medium or multiple media), such as the storage device 314, which includes complex programming instructions (e.g., complex computer-readable program code) to cause the processing circuitry 302 to carry out actions described herein. Thus, the computer-readable program code of the computer program 320 can comprise software instructions for implementing the functionality of the examples described herein when executed by the processing circuitry 302. In some examples, the storage device 314 may be a computer program product (e.g., readable storage medium) storing the computer program 320 thereon, where at least a portion of a computer program 320 may be loadable (e.g., into a processor) for implementing the functionality of the examples described herein when executed by the processing circuitry 302. The processing circuitry 302 may serve as a controller or control system for the computer system 300 that is to implement the functionality described herein.

The computer system 300 may include an input device interface 322 configured to receive input and selections to be communicated to the computer system 300 when executing instructions, such as from a keyboard, mouse, touch-sensitive surface, etc. Such input devices may be connected to the processing circuitry 302 through the input device interface 322 coupled to the system bus 306 but can be connected through other interfaces, such as a parallel port, an Institute of Electrical and Electronic Engineers (IEEE) 1394 serial port, a Universal Serial Bus (USB) port, an IR interface, and the like. The computer system 300 may include an output device interface 324 configured to forward output, such as to a display, a video display unit (e.g., a liquid crystal display (LCD) or a cathode ray tube (CRT)). The computer system 300 may include a communications interface 326 suitable for communicating with a network as appropriate or desired.

The operational actions described in any of the exemplary aspects herein are described to provide examples and discussion. The actions may be performed by hardware components, may be embodied in machine-executable instructions to cause a processor to perform the actions, or may be performed by a combination of hardware and software. Although a specific order of method actions may be shown or described, the order of the actions may differ. In addition, two or more actions may be performed concurrently or with partial concurrence.

According to certain examples, there is also disclosed:

Example 1: A computer system (300) comprising processing circuitry configured to: acquire a first set of parameters relating to a first unit (110-1) of a vehicle combination (100), the first set of parameters comprising a longitudinal acceleration of the first unit (110-1), a lateral acceleration of the first unit (110-1), a yaw rate of the first unit (110-1), and a first distance between the centre of gravity of the first unit (110-1) and a coupling point between the first unit (110-1) and a second unit (110-2) of the vehicle combination (100); acquire a second set of parameters relating to the second unit (110-2), the second set of parameters comprising a longitudinal tyre force of the second unit (110-2), a mass of the second unit (110-2), and a second distance between the centre of gravity of the second unit (110-2) and the coupling point; acquire a longitudinal coupling force and a lateral coupling force between the first unit (110-1) and the second unit (110-2); and determine an articulation angle between the first unit (110-1) and the second unit (110-2) based on the acquired first set of parameters, second set of parameters, longitudinal coupling force, and lateral coupling force.

Example 2: The computer system (300) of example 1, wherein: the first set of parameters further comprises a yaw acceleration of the first unit (110-1); and the processing circuitry is further configured to determine a longitudinal acceleration of the second unit (110-2) and/or a lateral acceleration of the second unit (110-2) based on the acquired first set of parameters, the acquired second set of parameters, and the determined articulation angle.

Example 3: The computer system (300) of example 2, wherein the processing circuitry is configured to determine a longitudinal acceleration of the second unit (110-2) based on the determined articulation angle, the longitudinal acceleration of the first unit (110-1), the lateral acceleration of the first unit (110-1), the yaw acceleration of the first unit (110-1), and the first distance.

Example 4: The computer system (300) of example 2 or 3, wherein the processing circuitry is configured to determine a lateral acceleration of the second unit (110-2) based on the determined articulation angle, the longitudinal acceleration of the first unit (110-1), the lateral acceleration of the first unit (110-1), the yaw acceleration of the first unit (110-1), the distance between the centre of gravity of the first unit (110-1) and the coupling point, and the second distance.

Example 5: The computer system (300) of any of examples 2 to 4, wherein the processing circuitry is further configured to use the longitudinal coupling force, the lateral coupling force, the articulation angle, the longitudinal acceleration of the second unit (110-2) and/or the lateral acceleration of the second unit (110-2) as an input to an inertial measurement unit, IMU, for motion management of the vehicle combination (100).

Example 6: The computer system (300) of any of examples 2 to 5, wherein the processing circuitry is configured to use the longitudinal coupling force, the lateral coupling force, the articulation angle, the longitudinal acceleration of the second unit (110-2) and/or the lateral acceleration of the second unit (110-2) to verify corresponding parameters of a separate vehicle motion or localization unit, a primary IMU of the vehicle combination (100), or global navigation satellite system, GNSS, based sensor equipment.

Example 7: The computer system (300) of any preceding example, wherein the processing circuitry is configured to acquire the longitudinal coupling force and the lateral coupling force by: acquiring a sum of longitudinal tyre forces of the first unit (110-1), a sum of lateral tyre forces of the first unit (110-1), and a mass of the first unit (110-1); and determining the longitudinal coupling force and the lateral coupling force based on the acquired longitudinal acceleration of the first unit (110-1), lateral acceleration of the first unit (110-1), sum of longitudinal tyre forces, sum of lateral tyre forces, and mass of the first unit.

Example 8: The computer system (300) of any preceding example, wherein the processing circuitry is configured to acquire at least some of the first set of parameters from a sensor system of the first unit (110-1) of the vehicle combination (100).

Example 9: The computer system (300) of any preceding example, wherein the processing circuitry is configured to acquire the longitudinal tyre force of the second unit (110-2) from a braking system and/or propulsion system of the second unit (110-2).

Example 10: The computer system (300) of any preceding example, wherein the computer system is an electronic control unit, ECU, (140-1) of the first unit (110-1), and the longitudinal coupling force, the lateral coupling force, the articulation angle, the longitudinal acceleration of the second unit (110-2) and/or the lateral acceleration of the second unit (110-2) are stored in a memory associated with the ECU (140-1) of the first unit (110-1).

Example 11: The computer system (300) of any preceding example, wherein the computer system is an electronic control unit, ECU, (140-2) of the second unit (110-2), wherein the processing circuitry is configured to use the longitudinal coupling force, the lateral coupling force, the articulation angle, the longitudinal acceleration of the second unit (110-2) and/or the lateral acceleration of the second unit (110-2) as a redundancy for determination of parameters by the second unit (110-2).

Example 12: A vehicle (100) comprising the computer system (300) of any preceding example.

Example 13: A computer-implemented method (200) comprising: acquiring (202), by processing circuitry of a computer system (300), a first set of parameters relating to a first unit (110-1) of a vehicle combination (100), the first set of parameters comprising a longitudinal acceleration of the first unit (110-1), a lateral acceleration of the first unit (110-1), a yaw rate of the first unit (110-1), and a distance between the centre of gravity of the first unit (110-1) and a coupling point between the first unit (110-1) and the second unit (110-2); acquiring (204), by the processing circuitry, a second set of parameters relating to a second unit (110-2) of the vehicle combination (100), the second set of parameters comprising a longitudinal tyre force of the second unit (110-2), a mass of the second unit (110-2), and a distance between the centre of gravity of the second unit (110-2) and the coupling point; and acquiring (206), by the processing circuitry, a longitudinal coupling force and a lateral coupling force between the first unit (110-1) and the second unit (110-2); and determining (208), by the processing circuitry, an articulation angle between the first unit (110-1) and the second unit (110-2) based on the acquired first set of parameters, second set of parameters, longitudinal coupling force, and lateral coupling force.

Example 14: The computer-implemented method (200) of example 13, wherein: the first set of parameters further comprises a yaw acceleration of the first unit (110-1); and the method comprises determining, by the processing circuitry, a longitudinal acceleration of the second unit (110-2) and/or a lateral acceleration of the second unit (110-2) based on the acquired first set of parameters, the acquired second set of parameters, and the determined articulation angle.

Example 15: The computer-implemented method (200) of example 14, comprising determining, by the processing circuitry, a longitudinal acceleration of the second unit (110-2) based on the determined articulation angle, the longitudinal acceleration of the first unit (110-1), the lateral acceleration of the first unit (110-1), the yaw acceleration of the first unit (110-1), and the first distance.

Example 16: The computer-implemented method (200) of example 14 or 15, comprising determining, by the processing circuitry, a lateral acceleration of the second unit (110-2) based on the determined articulation angle, the longitudinal acceleration of the first unit (110-1), the lateral acceleration of the first unit (110-1), the yaw acceleration of the first unit (110-1), the distance between the centre of gravity of the first unit (110-1) and the coupling point, and the second distance.

Example 17: The computer-implemented method (200) of any of examples 14 to 16, further comprising using, by the processing circuitry, the longitudinal coupling force, the lateral coupling force, the articulation angle, the longitudinal acceleration of the second unit (110-2) and/or the lateral acceleration of the second unit (110-2) as an input to an inertial measurement unit, IMU, for motion management of the vehicle combination (100).

Example 18: The computer-implemented method (200) of any of examples 14 to 17, comprising using, by the processing circuitry, the longitudinal coupling force, the lateral coupling force, the articulation angle, the longitudinal acceleration of the second unit (110-2) and/or the lateral acceleration of the second unit (110-2) to verify corresponding parameters of a separate vehicle motion or localization unit, a primary IMU of the vehicle combination (100), or global navigation satellite system, GNSS, based sensor equipment.

Example 19: The computer-implemented method (200) of any of examples 13 to 18, comprising acquiring, by the processing circuitry, the longitudinal coupling force and the lateral coupling force by: acquiring a sum of longitudinal tyre forces of the first unit (110-1), a sum of lateral tyre forces of the first unit (110-1), and a mass of the first unit (110-1); and determining, by the processing circuitry, the longitudinal coupling force and the lateral coupling force based on the acquired longitudinal acceleration of the first unit (110-1), lateral acceleration of the first unit (110-1), sum of longitudinal tyre forces, sum of lateral tyre forces, and mass of the first unit.

Example 20: The computer-implemented method (200) of any of examples 13 to 19, comprising acquiring, by the processing circuitry, at least some of the first set of parameters from a sensor system of the first unit (110-1) of the vehicle combination (100).

Example 21: The computer-implemented method (200) of any of examples 13 to 20, comprising acquiring, by the processing circuitry, the longitudinal tyre force of the second unit (110-2) from a braking system and/or propulsion system of the second unit (110-2).

Example 22: The computer-implemented method (200) of any of examples 13 to 21, wherein the computer system is an electronic control unit, ECU, (140-1) of the first unit (110-1), and the longitudinal coupling force, the lateral coupling force, the articulation angle, the longitudinal acceleration of the second unit (110-2) and/or the lateral acceleration of the second unit (110-2) are stored in a memory associated with the ECU (140-1) of the first unit (110-1).

Example 23: The computer-implemented method (200) of any of examples 13 to 22, wherein the computer system is an electronic control unit, ECU, (140-2) of the second unit (110-2), the method comprising using, by the processing circuitry, the longitudinal coupling force, the lateral coupling force, the articulation angle, the longitudinal acceleration of the second unit (110-2) and/or the lateral acceleration of the second unit (110-2) as a redundancy for determination of parameters by the second unit (110-2).

Example 24: A computer program product comprising program code for performing, when executed by processing circuitry, the computer-implemented method (200) of any of examples 13 to 23.

Example 25: A non-transitory computer-readable storage medium comprising instructions, which when executed by processing circuitry, cause the processing circuitry to perform the computer-implemented method (200) of any of examples 13 to 23.

Example 26: A computer system comprising processing circuitry configured to: acquire a first set of parameters relating to a first unit (110-1) of a vehicle combination (100); acquire a second set of parameters relating to a second unit (110-2) of the vehicle combination (100); determine a third set of parameters relating to the second unit (110-2) of the vehicle combination (100) based on the acquired first and second sets of parameters; and use the third set of parameters as an input to an inertial measurement unit, IMU, for motion management of the vehicle combination (100), or to verify corresponding parameters of a separate vehicle motion or localization unit, a primary IMU of the vehicle combination (100), or global navigation satellite system, GNSS, based sensor equipment

Example 27: The computer system of example 26, wherein the first set of parameters comprises a longitudinal acceleration of the first unit (110-1), a lateral acceleration of the first unit (110-1), a yaw rate of the first unit (110-1), and a first distance between the centre of gravity of the first unit (110-1) and a coupling point between the first unit (110-1) and a second unit (110-2) of the vehicle combination (100), optionally a yaw acceleration of the first unit (110-1), and optionally a sum of longitudinal tyre forces of the first unit (110-1), a sum of lateral tyre forces of the first unit (110-1), and a mass of the first unit (110-1).

Example 28: The computer system of example 26 or 27, wherein the second set of parameters comprises a longitudinal tyre force of the second unit (110-2), a mass of the second unit (110-2), and a second distance between the centre of gravity of the second unit (110-2) and the coupling point.

Example 29: The computer system of any of examples 26 to 28, wherein the third set of parameters comprises an articulation angle between the first unit (110-1) and the second unit (110-2), optionally a longitudinal coupling force and a lateral coupling force between the first unit (110-1) and the second unit (110-2), and optionally a longitudinal acceleration of the second unit (110-2) and/or a lateral acceleration of the second unit (110-2).

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

What is claimed is:

1. A computer system comprising processing circuitry configured to:
acquire a first set of parameters relating to a first unit of a vehicle combination, the first set of parameters comprising a longitudinal acceleration of the first unit, a lateral acceleration of the first unit, a yaw rate of the first unit, and a first distance between the centre of gravity of the first unit and a coupling point between the first unit and a second unit of the vehicle combination;
acquire a second set of parameters relating to the second unit, the second set of parameters comprising a longitudinal tyre force of the second unit, a mass of the second unit, and a second distance between the centre of gravity of the second unit and the coupling point;
acquire a longitudinal coupling force and a lateral coupling force between the first unit and the second unit; and
determine an articulation angle between the first unit and the second unit) based on the acquired first set of parameters, second set of parameters, longitudinal coupling force, and lateral coupling force.

2. The computer system of claim 1, wherein:
the first set of parameters further comprises a yaw acceleration of the first unit; and
the processing circuitry is further configured to determine a longitudinal acceleration of the second unit and/or a lateral acceleration of the second unit based on the acquired first set of parameters, the acquired second set of parameters, and the determined articulation angle.

3. The computer system of claim 2, wherein the processing circuitry is configured to determine the longitudinal acceleration of the second unit based on the determined articulation angle, the longitudinal acceleration of the first unit, the lateral acceleration of the first unit, the yaw acceleration of the first unit, and the first distance.

4. The computer system of claim 2, wherein the processing circuitry is configured to determine the lateral acceleration of the second unit based on the determined articulation angle, the longitudinal acceleration of the first unit, the lateral acceleration of the first unit, the yaw acceleration of the first unit, the distance between the centre of gravity of the first unit and the coupling point, and the second distance.

5. The computer system of claim 2, wherein the processing circuitry is further configured to use the longitudinal coupling force, the lateral coupling force, the articulation angle, the longitudinal acceleration of the second unit and/or the lateral acceleration of the second unit as an input to an inertial measurement unit, IMU, for motion management of the vehicle combination.

6. The computer system of claim 2, wherein the processing circuitry is configured to use the longitudinal coupling force, the lateral coupling force, the articulation angle, the longitudinal acceleration of the second unit and/or the lateral acceleration of the second unit to verify corresponding parameters of a separate vehicle motion or localization unit, a primary IMU of the vehicle combination, or global navigation satellite system, GNSS, based sensor equipment.

7. The computer system of claim 1, wherein the processing circuitry is configured to acquire the longitudinal coupling force and the lateral coupling force by:
acquiring a sum of longitudinal tyre forces of the first unit, a sum of lateral tyre forces of the first unit, and a mass of the first unit; and
determining the longitudinal coupling force and the lateral coupling force based on the acquired longitudinal acceleration of the first unit, lateral acceleration of the first unit, sum of longitudinal tyre forces, sum of lateral tyre forces, and mass of the first unit.

8. The computer system of claim 1, wherein the processing circuitry is configured to acquire at least some of the first set of parameters from a sensor system of the first unit of the vehicle combination.

9. The computer system of claim 1, wherein the processing circuitry is configured to acquire the longitudinal tyre force of the second unit from a braking system and/or propulsion system of the second unit.

10. The computer system of claim 1, wherein the computer system is an electronic control unit, ECU, of the first unit, and the longitudinal coupling force, the lateral coupling force, the articulation angle, the longitudinal acceleration of the second unit and/or the lateral acceleration of the second unit are stored in a memory associated with the ECU of the first unit.

11. The computer system of claim 1, wherein the computer system is an electronic control unit, ECU, of the second unit, wherein the processing circuitry is configured to use the longitudinal coupling force, the lateral coupling force, the articulation angle, the longitudinal acceleration of the second unit and/or the lateral acceleration of the second unit as a redundancy for determination of parameters by the second unit.

12. A vehicle comprising the computer system of claim 1.

13. A computer system comprising processing circuitry configured to:
acquire a first set of parameters relating to a first unit of a vehicle combination;
acquire a second set of parameters relating to a second unit of the vehicle combination;
determine a third set of parameters relating to the second unit of the vehicle combination based on the acquired first and second sets of parameters; and
use the third set of parameters as an input to an inertial measurement unit, IMU, for motion management of the vehicle combination, or to verify corresponding parameters of a separate vehicle motion or localization unit, a primary IMU of the vehicle combination, or global navigation satellite system, GNSS, based sensor equipment.

14. The computer system of claim 13, wherein the first set of parameters comprises a longitudinal acceleration of the first unit, a lateral acceleration of the first unit, a yaw rate of the first unit, and a first distance between the centre of gravity of the first unit and a coupling point between the first unit and a second unit of the vehicle combination.

15. The computer system of claim 13, wherein the second set of parameters comprises a longitudinal tyre force of the second unit, a mass of the second unit, and a second distance between the centre of gravity of the second unit and the coupling point.

16. The computer system of claim 13, wherein the third set of parameters comprises an articulation angle between the first unit and the second unit, optionally a longitudinal coupling force and a lateral coupling force between the first unit and the second unit, and optionally a longitudinal acceleration of the second unit and/or a lateral acceleration of the second unit.

17. A computer-implemented method comprising:
acquiring, by processing circuitry of a computer system, a first set of parameters relating to a first unit of a vehicle combination, the first set of parameters comprising a longitudinal acceleration of the first unit, a lateral acceleration of the first unit, a yaw rate of the first unit, and a distance between the centre of gravity of the first unit and a coupling point between the first unit and the second unit;
acquiring, by the processing circuitry, a second set of parameters relating to a second unit of the vehicle combination, the second set of parameters comprising a longitudinal tyre force of the second unit, a mass of the second unit, and a distance between the centre of gravity of the second unit and the coupling point; and
acquiring, by the processing circuitry, a longitudinal coupling force and a lateral coupling force between the first unit and the second unit; and
determining, by the processing circuitry, an articulation angle between the first unit and the second unit based on the acquired first set of parameters, second set of parameters, longitudinal coupling force, and lateral coupling force.

18. A computer program product comprising program code for performing, when executed by processing circuitry, the computer-implemented method of claim 17.

19. A non-transitory computer-readable storage medium comprising instructions, which when executed by processing circuitry, cause the processing circuitry to perform the computer-implemented method of claim 17.
